(19) United States
(12) Patent Application Publication
(10) Pub. No.: US 2005/0271437 A1
(43) Pub. Date: Dec. 8, 2005

(54) Printing condition setting method, program, printing method, printing apparatus, and printing condition decision device

(75) Inventors: Tetsuya Edamura, Kanagawa-ken (JP); Kiichiro Takahashi, Kanagawa-ken (JP); Minoru Teshigawara, Kanagawa-ken (JP); Haruyuki Yanagi, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHlKI KAISHA, Tokyo (JP)

(21) Appl. No.: 11/146,133

(22) Filed: Jun. 7, 2005

(30) Foreign Application Priority Data
Jun. 8, 2004 (JP) 170464/2004

(51) Int. Cl. B41J 29/38

(52) U.S. Cl. 400/76

(57) ABSTRACT

This invention minimizes a consumption of a colorant during a so-called margin-less printing and alleviates a contamination of an interior of a printing apparatus. For this purpose, when forming an image by applying a colorant to an area overrunning outwardly from the print medium, a width of overrun from the print medium in a colorant application area is adjusted according to a kind and a size of the print medium.

### BACKGROUND OF THE INVENTION

1. Field of the Invention

The present invention relates to a printing condition setting method and program for setting a condition under which an image is formed on a print medium by applying a colorant also to an area overrunning outwardly from the print medium. This invention also relates to a printing method, a printing apparatus and a printing condition deciding device to perform such a printing.

2. Description of the Related Art

Recent years have seen a remarkable advance in printing apparatus technology, such as ink jet printing systems, which has resulted in significant improvements in printed image quality and printing speed. In the development of printing apparatus products in recent years, efforts are being focused on improvements of added functions for printing and on improved ease of use, as well as improvements in fundamental performances such as print quality and printing speed. For example, a printing apparatus has been proposed which can perform a so-called margin-less printing (edge-to-edge printing), which prints an image on a print medium by not forming a margin at at least one edge portion of the print medium (e.g., Japanese Patent Application Laid-open Nos. 2002-103585, 2002-103587, 2003-127353, and 2003-177898).

One example of a serial scan type ink jet printing apparatus capable of performing a margin-less printing is described below. In the printing apparatus, a platen supporting a print medium at a print position is constructed as shown in FIG. 1A and FIG. 1B, for example. The serial scan type ink jet printing apparatus forms an image progressively on a print medium P by repetitively alternating an operation, which involves moving a carriage mounting an ink jet print head in a main scan direction indicated by an arrow X while at the same time ejecting ink from the print head onto the print medium P, and an operation, which involves feeding the print medium P a predetermined distance in a subscan direction indicated by an arrow Y.

In FIG. 1A and FIG. 1B, the platen 10 is arranged almost horizontal to face the print head that moves along with the carriage. The platen has ribs 11, 12 protruding upward. The print medium P is transported in the subscan direction Y by transport rollers as it is supported on the top of the ribs 11, 12. A groove 14 formed between the ribs 11 and ribs 12 (also called an “ink receiving portion”) receives ink ejected outside edge portions of the print medium P during the margin-less printing, which prints on the print medium P without providing a margin at the edge portions of the print medium. In a lower part of the groove 14 and in a lower part between the ribs is installed an ink absorbent 13 that absorbs ink (also referred to as a “platen absorbent”).

FIG. 2A, FIG. 2B and FIG. 2C illustrate how a margin-less printing is performed on the print medium P by using the above platen 10.

The serial scan type ink jet printing apparatus, as described above, intermittently feeds the print medium P in the subscan direction (Y direction) following each printing operation of the print head in the main scan direction (X direction). At the start of the printing operation, the print medium P is supplied onto the platen 10 by a feed mechanism. At this time, a front end portion Pa of the supplied print medium P stops over the groove 14 formed between the ribs 11 and ribs 12 of the platen 10, as shown in FIG. 2A.

Next, as shown in FIG. 2B, the print head H1001 is made to eject ink droplets onto the print medium P as the carriage mounting the print head H1001 is moved in the main scan direction X, to print a first line at the front end portion Pa of the print medium P. Print data to form an image on the print medium P is set larger in size than the print medium P. Therefore, based on the print data, ink is ejected to cover positions deviated outwardly from the front end portion Pa of the print medium P, thus forming an image up to the front end portion Pa without leaving a margin at the front end portion Pa. Ink ejected to those positions deviated outwardly from the front end portion Pa of the print medium P, i.e., ink applied to positions where the print medium P does not exist, lands on the ink absorbent 13 (platen absorbent) between the ribs 11 and 12, where it is absorbed and held.

By ejecting ink so as to cover those positions deviated outwardly from left and right edge portions of the print medium P according to the print data, an image can be formed to the left and right edges without forming a margin at the left and right edge portions. Ink applied to those positions deviated outwardly from the left and right edges of the print medium P is also absorbed and held by the ink absorbent 13 (platen absorbent).

After the printing operation on the first line is completed as described above, the LF rollers provided in the transport mechanism are rotated to feed the print medium P a predetermined distance in the subscan direction Y, followed by the printing operation for the next line. These two operations are performed alternately. Then, when a rear end portion Pb of the print medium P moves over the platen 10, as shown in FIG. 2C, the printing operation for the last one line is performed. By ejecting ink so as to cover those positions deviated outwardly from the rear end portion Pb according to the print data, it is possible to form an image to the rear edge portion Pb without forming a margin at the rear edge portion Pb. Ink applied to the positions outside the rear edge portion Pb of the print medium P is absorbed and held by the ink absorbent 13 (platen absorbent).

In such a margin-less printing, print data used is larger in size than the print medium P. The reason for this arrangement is that the precise position and size of the print medium P cannot be determined due to positional deviation of the print medium during transport and print medium size variations. If the print data that matches the size of the print medium P is used, there is a possibility that blank portions with no image printed may be formed at edge portions of the print medium P.

As for the positional deviations of print media, the amount of positional deviation changes with the print medium size even if the inclination angles are equal. Depending on the kind of print medium, the amount of positional deviation may vary due to differences in characteristics. Further, depending on the size and kind of print medium, cutting precision may differ resulting in different size variations from a standard size. So, to ensure that the margin-less printing is reliably executed with no margins formed at the edge portions of the print medium, the print data size needs to be set by considering a maximum possible positional deviation of the print medium that may occur in the printing apparatus and a maximum possible print medium size variation caused by cutting precision errors. Generally, the width of an area, in which no margin is formed at edge portions of the print medium if the maximum print medium positional deviation considered possible in the printing apparatus should occur, is set in advance and, during the margin-less printing, print data is generated which is equal in size to the set area width added to the maximum value of the print medium standard size.

In a printing apparatus described above, when, during the margin-less printing, ink droplets are applied to positions deviated outwardly from the print medium and land on the absorbent in the platen to be absorbed there, the following problems need to be addressed.

First, since ink droplets that do not contribute to an image forming are ejected to positions deviated outwardly from the print medium, an ink consumption increases.

Of the ink droplets ejected from the print head, those of small volumes may decelerate, float around and be carried on air flows inside the printing apparatus, adhering to and contaminating the interior of the printing apparatus. In normal printing (not the margin-less printing), the distance that the ink droplets fly from the print head to the print medium is relatively short. Thus, ink droplets land on the print medium before they decelerate, so there is little chance of the ink droplets floating around and contaminating the interior of the printing apparatus. However, during the margin-less printing, ink droplets ejected at positions outside the print medium fly a relatively long distance between the print head and the absorbent installed on the platen. During their flight the ink droplets easily decelerate and float around and are very likely to contaminate the interior of the printing apparatus.

To reduce the ink consumption and the possibility of interior contamination during the margin-less printing, one effective method is to reduce the amount of ink ejected to an area outside the print medium. It is therefore effective to minimize the overrunning width. Conventional methods, however, do not consider characteristics of print media (size and kind of print media) in setting the overrunning width and have some drawbacks that need to be addressed in reducing the ink consumption and interior contamination.

### SUMMARY OF THE INVENTION

An object of this invention is to provide a printing condition setting method, a program, a printing method, a printing apparatus and a printing condition deciding device, which can reduce a consumption of colorant and a contamination of interior of the printing apparatus during a so-called margin-less printing.

In a first aspect of the present invention, there is provided a printing condition setting method for setting a condition which is used to perform a margin-less printing, the margin-less printing performing printing on a print medium without providing a margin at an edge portion of the print medium by applying a colorant to the print medium based on print data larger in size than the print medium to be printed, the printing condition setting method comprising:
a step of specifying an overrunning width of the print data that overruns outwardly from the print medium to be printed;
wherein the specifying step specifies the overrunning width according to a kind and a size of the print medium to be printed.

In a second aspect of the present invention, there is provided a printing condition setting method for setting a condition which is used to perform a margin-less printing, the margin-less printing performing printing on a print medium without providing a margin at an edge portion of the print medium by applying a colorant to the print medium based on print data larger in size than the print medium to be printed, the printing condition setting method comprising:
a step of specifying an overrunning width of the print data that overruns outwardly from the print medium to be printed;
wherein the specifying step specifies the overrunning width according to at least one of a kind and a size of the print medium to be printed and to one level selected from a plurality of levels representing magnitudes of the overrunning width.

In a third aspect of the present invention, there is provided a program for setting a condition which is used to perform a margin-less printing, the margin-less printing performing printing on a print medium without providing a margin at an edge portion of the print medium by applying a colorant to the print medium based on print data larger in size than the print medium to be printed,
the program causing a computer to execute a step of specifying an overrunning width of the print data that overruns outwardly from the print medium to be printed;
wherein the specifying step specifies the overrunning width according to at least one of a kind and a size of the print medium to be printed and to one level selected from a plurality of levels representing magnitudes of the overrunning width.

In a fourth aspect of the present invention, there is provided a program for setting a condition which is used to perform a margin-less printing, the margin-less printing performing printing on a print medium without leaving a margin at an edge portion of the print medium by applying a colorant to the print medium based on print data larger in size than the print medium to be printed,
the program causing a computer to execute a step of specifying an overrunning width of the print data, which overruns outwardly from the print medium to be printed, according to a kind and a size of the print medium.

In a fifth aspect of the present invention, there is provided a printing method for executing a margin-less printing, the margin-less printing performing printing on a print medium without leaving a margin at an edge portion of the print medium by applying a colorant to the print medium based on print data larger in size than the print medium to be printed, the printing method comprising the steps of:
a step of specifying an overrunning width of the print data, which overruns outwardly from the print medium, according to at least one of a kind and a size of the print medium to be printed and to one level selected from a plurality of levels representing magnitudes of the overrunning width;
a step of generating the print data larger in size than the print medium to be printed, according to the specified overrunning width; and
a step of applying the colorant to the print medium according to the generated print data.

In a sixth aspect of the present invention, there is provided a printing method for executing a margin-less printing, the margin-less printing performing printing on a print medium without providing a margin at an edge portion of the print medium by applying a colorant to the print medium based on print data larger in size than the print medium to be printed, the printing method comprising the steps of:
a step of specifying an overrunning width of the print data, which overruns outwardly from the print medium to be printed, according to a kind and a size of the print medium;
a step of generating the print data larger in size than the print medium to be printed, according to the specified overrunning width; and
a step of applying the colorant to the print medium according to the generated print data.

In a seventh aspect of the present invention, there is provided a printing apparatus for executing a margin-less printing, the margin-less printing performing printing on a print medium without providing a margin at an edge portion of the print medium by applying a colorant to the print medium based on print data larger in size than the print medium to be printed, the printing apparatus comprising:
means for specifying an overrunning width of the print data, which overruns outwardly from the print medium, according to at least one of a kind and a size of the print medium to be printed and to one level selected from a plurality of levels representing magnitudes of the overrunning width;
means for generating the print data larger in size than the print medium to be printed, according to the specified overrunning width; and
means for applying the colorant to the print medium according to the generated print data.

In an eighth aspect of the present invention, there is provided a printing apparatus for executing a margin-less printing, the margin-less printing performing printing on a print medium without providing a margin at an edge portion of the print medium by applying a colorant to the print medium based on print data larger in size than the print medium to be printed, the printing apparatus comprising:
means for specifying an overrunning width of the print data, which overruns outwardly from the print medium to be printed, according to a kind and a size of the print medium to be printed;
means for generating the print data larger in size than the print medium to be printed, according to the specified overrunning width; and
means for applying the colorant to the print medium according to the generated print data.

In a ninth aspect of the present invention, there is provided a printing condition deciding apparatus capable of determining a condition under which to perform a margin-less printing, the margin-less printing performing printing on a print medium without leaving a margin at an edge portion of the print medium by applying a colorant to the print medium based on print data larger in size than the print medium to be printed, the printing condition deciding apparatus comprising:
means for specifying an overrunning width of the print data that overruns outwardly from the print medium to be printed;
means for generating the print data according to the overrunning width specified by the specifying means; and
means for transferring the generated print data to a printing apparatus that performs the margin-less printing;
wherein the specifying means specifies the overrunning width according to at least one of a kind and a size of the print medium to be printed and to one level selected from a plurality of levels representing magnitudes of the overrunning width.

In a tenth aspect of the present invention, there is provided a printing condition deciding apparatus capable of determining a condition under which to perform a margin-less printing, the margin-less printing performing printing on a print medium without leaving a margin at an edge portion of the print medium by applying a colorant to the print medium based on print data larger in size than the print medium to be printed, the printing condition deciding apparatus comprising:
means for specifying an overrunning width of the print data, which overruns outwardly from the print medium to be printed, according to a kind and a size of the print medium;
means for generating the print data according to the overrunning width specified by the specifying means; and
means for transferring the generated print data to a printing apparatus that performs the margin-less printing.

In this specification, “margin-less printing” means performing a printing by not providing a margin at at least one end (one end portion) of a print surface of a print medium. When a print medium is rectangular, for example, the “margin-less printing” as used in this specification includes not only a case where a margin is not provided at any of the four sides, but also includes a case where a margin is not provided at three sides but is provided at one remaining side, a case where it is not provided at two sides but is provided at two remaining sides, and a case where it is not provided at one side but is provided at three remaining sides.

With this invention, when an image is formed by applying a colorant so as to cover an area overrunning outwardly from the print medium, an overrunning width of the colorant application area is adjusted according to the kind and size of the print medium. This reduces a consumption of the colorant and a contamination of the interior of the printing apparatus during a so-called margin-less printing.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1A is a perspective view showing an example construction of a platen capable of performing a margin-less printing; and FIG. 1B is a cross-sectional view of the platen;

FIGS. 2A, 2B and 2C are cross-sectional views showing how the margin-less printing is performed using the platen of FIG. 1A;

FIG. 3 is an explanatory diagram showing a relation between a printing apparatus and a control apparatus in a first embodiment of the invention;

FIG. 4 is a perspective view of an essential portion showing an example construction of the printing apparatus of FIG. 3;

FIG. 5 is an exploded perspective view showing an example construction of an ink jet cartridge of FIG. 4;

FIG. 6 is an enlarged cross-sectional view showing an example construction of a print head of FIG. 5;

FIG. 7 is a flow chart showing a sequence of printing operations performed in the first embodiment of the invention;

FIG. 8A is an explanatory diagram showing an amount of deviation when a print medium is tilted at a relatively small angle as it is transported; and

FIG. 8B is an explanatory diagram showing an amount of deviation when the print medium is tilted at a relatively large angle as it is transported;

FIG. 9 is an explanatory diagram showing the specific amount of deviation when the print medium is transported in a tilted attitude;

FIG. 10A is an explanatory diagram showing a relation between a print medium size and an overrunning width set in the first embodiment of the invention; FIG. 10B is an explanatory diagram showing variations of the print medium size set in the first embodiment of the invention; and FIG. 10C is an explanatory diagram showing a relation, set in the first embodiment of the invention, between the print medium size and the amount of deviation during print medium feeding in a tilted state;

FIG. 11 is an explanatory diagram illustrating a user interface screen used in the first embodiment of the invention;

FIG. 12 is a flow chart showing a sequence of printing operations performed in a second embodiment of the invention;

FIGS. 13A, 13B and 13C are explanatory diagrams illustrating user interfaces used in the second embodiment of the invention;

FIG. 14 is an explanatory diagram showing a relation between an adjust level and an amount of deviation set in the second embodiment of the invention;

FIG. 15 is a flow chart showing a sequence of printing operations performed in a third embodiment of the invention; and

FIG. 16 is an explanatory diagram showing a relation between a kind of print medium and an amount of deviation set in the third embodiment of the invention.

### DETAILED DESCRIPTION OF PREFERRED EMBODIMENTS

Now, embodiments of the present invention will be described by referring to the accompanying drawings.

### First Embodiment

(Overall Construction)

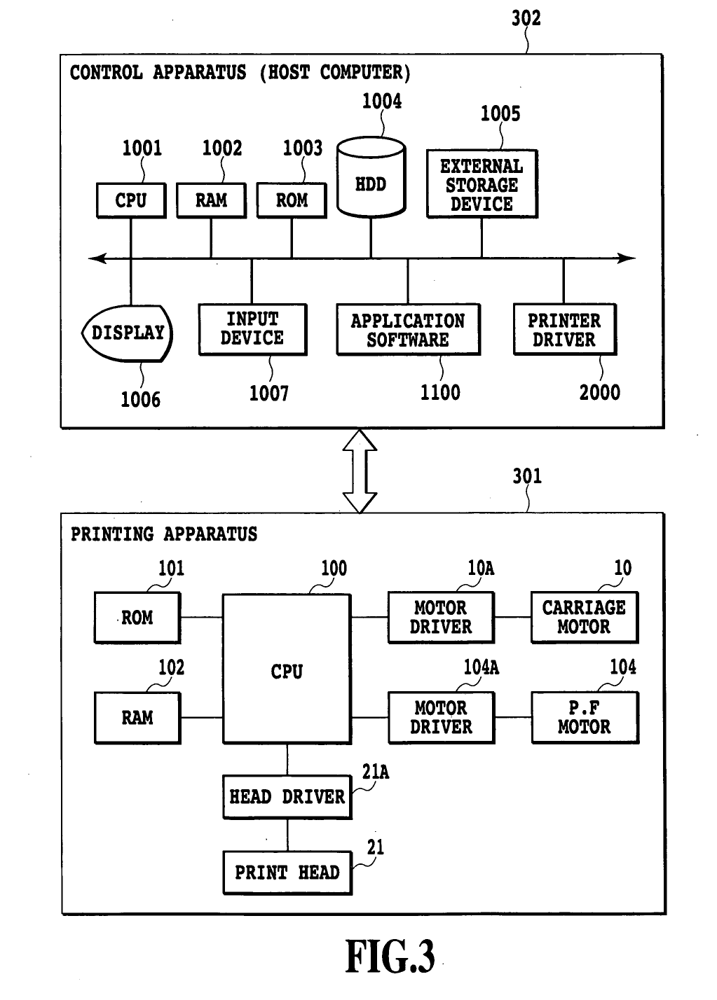

FIG. 3 shows a relation between a printing apparatus 301 and a control apparatus (host computer) 302. The printing apparatus 301 and the control apparatus 302 constitute a print system and are connected to each other through a known communication means for mutual communication. The control apparatus 302 operates based on a user instruction and transforms image data into print data before sending it to the printing apparatus 301. The printing apparatus 301 forms an image on a print medium based on the print data. The printing apparatus 301 can perform a margin-less printing and a normal printing, as detailed later.

The computer 302 has a known configuration equipped with a CPU 1001, a RAM 1002, a ROM 1003, a hard disk drive (HDD) 1004, a display 1006, and an input device 1007 such as keyboard and mouse. It also has an external storage device 1005. The external storage device 1005 includes, for example, removable storage media (e.g., DVD-ROMs, CD-ROMs, PDs, MOs, FDs, JAZZ (registered trademark), ZIP (registered trademark), and a variety of kinds of magnetic tapes), to and from which data and programs are freely read and written. The RAM 1002 is used as a work area for the CPU 1001 and to temporarily store data.

The computer 302 loads a variety of application software and a printer driver 2000 as well as programs of this invention from the external storage device 1005 into the hard disk drive 1004 or RAM 1002 so that they can be executed by the CPU 1001. The printer driver 2000 when executed performs a characteristic function as described later.

In addition to storage media, such as hard disk and RAM, the printer driver 2000 can be loaded into various read/write media for execution. The printer driver 2000 can also be stored in a nonvolatile memory such as ROM and NVRAM in advance or loaded from other devices into the storage device through networks. Print data prepared by the printer driver 2000 is transmitted from a transmission unit not shown to a receiving unit not shown of the printer 301.

In the printing apparatus 301, a CPU 100 controls the operation of the printing apparatus 301 and processes data. A ROM 101 stores a program defining a sequence of these operations, and a RAM 102 is used as a work area for processing. Ejection of ink (colorant) from a print head 21, which is detailed later, is executed by the CPU 100 supplying drive data (image data) and a drive control signal (heat pulse signal) for ejection heaters (electrothermal transducers) to a head driver 21A. The CPU 100 controls a carriage motor 10, which drives a carriage (carriage unit) in a main scan direction, through a motor driver 10A. It also controls a P.F motor 104, which feeds a print medium in a subscan direction, through a motor driver 104A.

(Construction of Printing Apparatus)

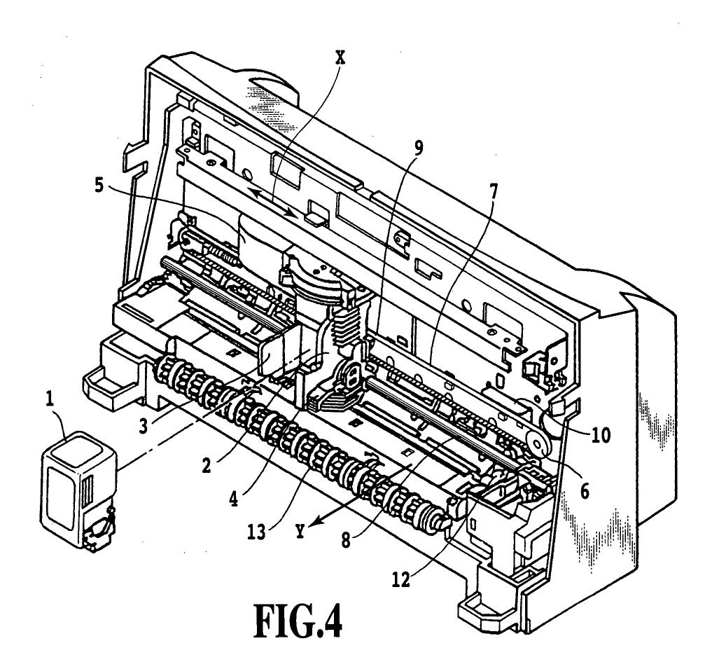

FIG. 4 is a perspective view of a serial scan type ink jet printing apparatus to which this invention can be applied, with its front cover removed to expose the inner construction.

Denoted 1 is a replaceable ink jet cartridge which has an ink tank and an ink jet print head, as described later. Designated 2 is a carriage unit to removably hold the ink jet cartridge 1. Designated 3 is a holder to fix the ink jet cartridge 1 to the carriage unit 2. When, with the ink jet cartridge 1 installed in the carriage unit 2, a cartridge fixing lever 4 is operated, an ink jet cartridge 1000 is pressed against the carriage unit 2. This engagement under pressure causes the ink jet cartridge 1000 to be positioned in its place and at the same time a signal transmission electric contact on the carriage unit 2 to be connected to an electric contact on the ink jet cartridge 1 side. Denoted 5 is a flexible cable to transfer an electric signal to the carriage unit 2.

Designated 6 is a carriage motor as a drive source to reciprocate the carriage unit 2 in a main scan direction indicated by an arrow X. Denoted 7 is a carriage belt to transmit a drive force of the carriage motor 6 to the carriage unit 2. A guide shaft 8 extending in the main scan direction movably guides the carriage unit 2 along its length. The carriage unit 2 has a transmission type photocoupler 9. A light shield plate 10 is placed near a home position of the carriage unit 2. When the carriage unit 2 reaches its home position, the light shield plate 10 interrupts a light path of the photocoupler 9, detecting that the carriage unit 2 has reached the home position. A home position unit 12 includes a cap member that caps a front surface of the print head in the ink jet cartridge, a suction means to perform a sucking operation on the interior of the cap member, and a wipe member to wipe the front surface of the print head.

A discharge roller 13 for discharging a print medium holds the print medium between it and a spur roller not shown and moves it in the subscan direction indicated by arrow Y to discharge the printed medium out of the printing apparatus. In the printing apparatus, there is a line feed unit (not shown) that feeds the print medium in the subscan direction a predetermined distance at a time. On the print medium transport path a paper end sensor is provided which detects when an end of the print medium approaches (PE sensor).

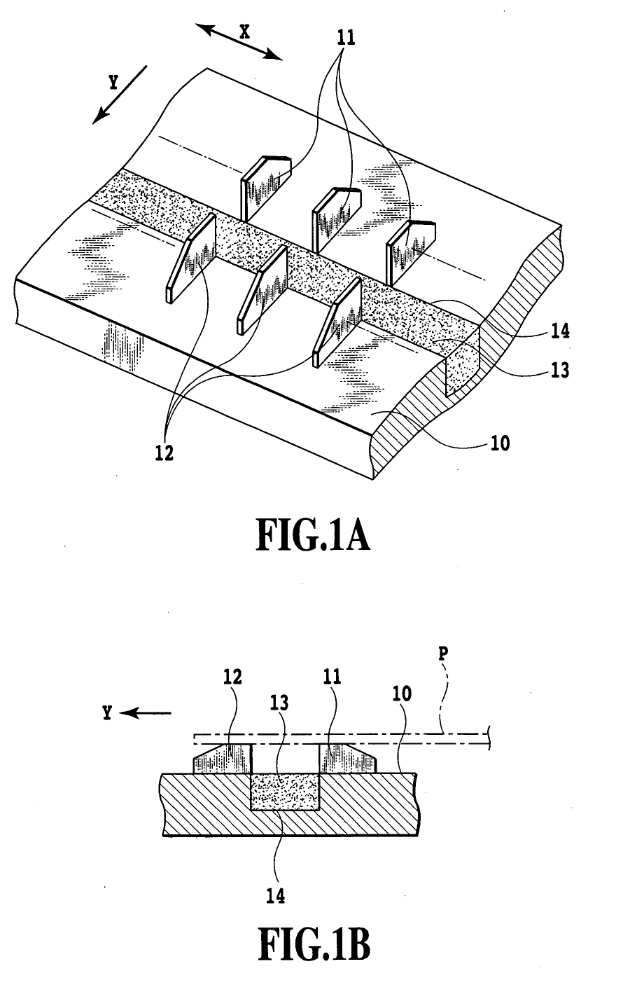

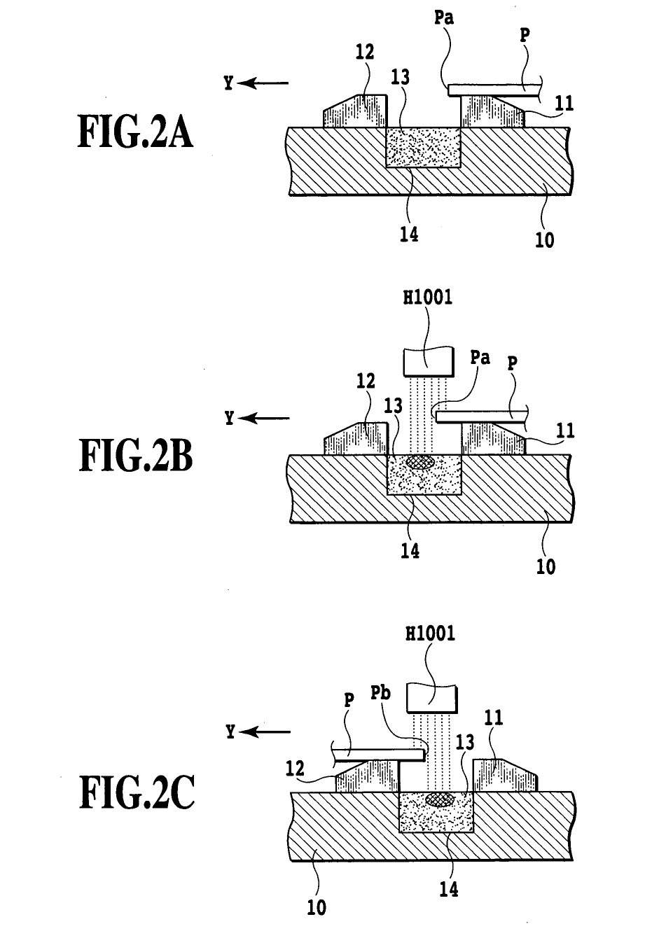

The printing apparatus of this embodiment can perform a margin-less printing or edge-to-edge printing, which forms an image to an edge of at least one end portion of the print medium by eliminating a margin at that end portion, and a normal printing, which forms an image with a margin left at end portions of the print medium. To realize the margin-less printing, the platen shown in FIG. 1 and FIG. 2 may be used. In that case, ink ejected at positions outside the edges of the print medium during the margin-less printing can be absorbed and contained in an ink absorbent installed in a groove of the platen as described above.

(Head Construction)

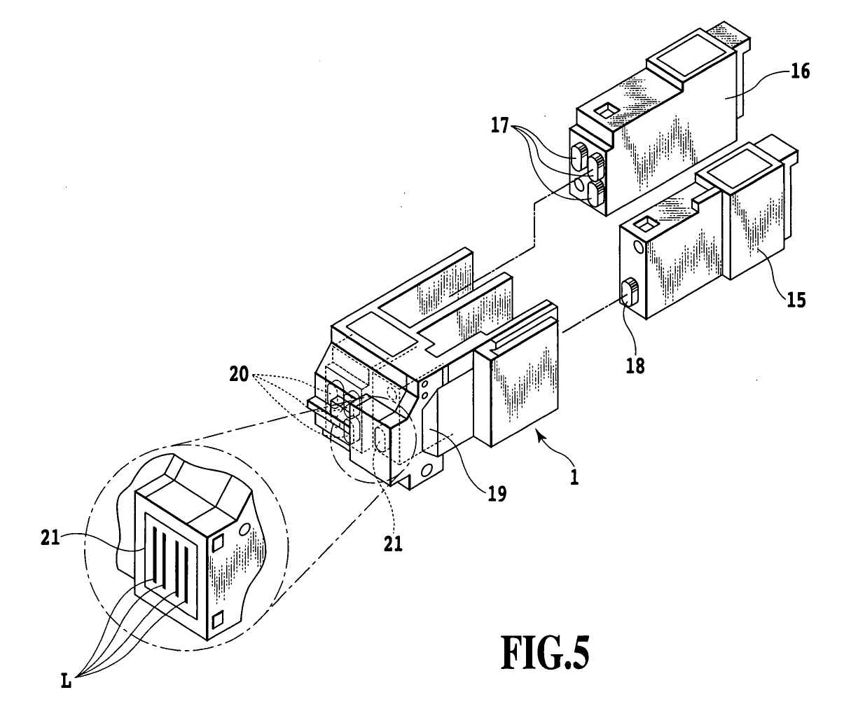

FIG. 5 is an exploded perspective view showing a detailed construction of the ink jet cartridge 1.

In FIG. 5, designated 15 is an ink tank containing a black (Bk) ink and 16 refers to an ink tank containing cyan (C), magenta (M) and yellow (Y) inks separately. These ink tanks 15, 16 are replaceably mounted on a body of the ink jet cartridge 1 (also referred to as a “cartridge body”). Denoted 17 are ink supply ports of the ink tank 16 for C, M and Y inks which connect with corresponding supply pipes 20 on the cartridge body side to supply the C, M and Y inks. Denoted 18 is an ink supply port of the ink tank 15 for Bk ink which connects with a corresponding supply pipe 20 on the cartridge body side to supply the Bk ink. The Bk, C, M and Y inks are supplied to the ink jet print head 21 through the corresponding supply pipes 20. An electric contact portion 19 connected to the flexible cable 5 supplies a drive signal based on print data to the print head 21.

The print head 21 has four nozzle columns L, each made up of a plurality of nozzles, to eject Bk, C, M and Y inks. The nozzle columns L are arranged in a direction crossing the subscan direction of arrow Y (in this example, a main scan direction perpendicular to the subscan direction). Each of the nozzles forms an ink ejection opening or orifice.

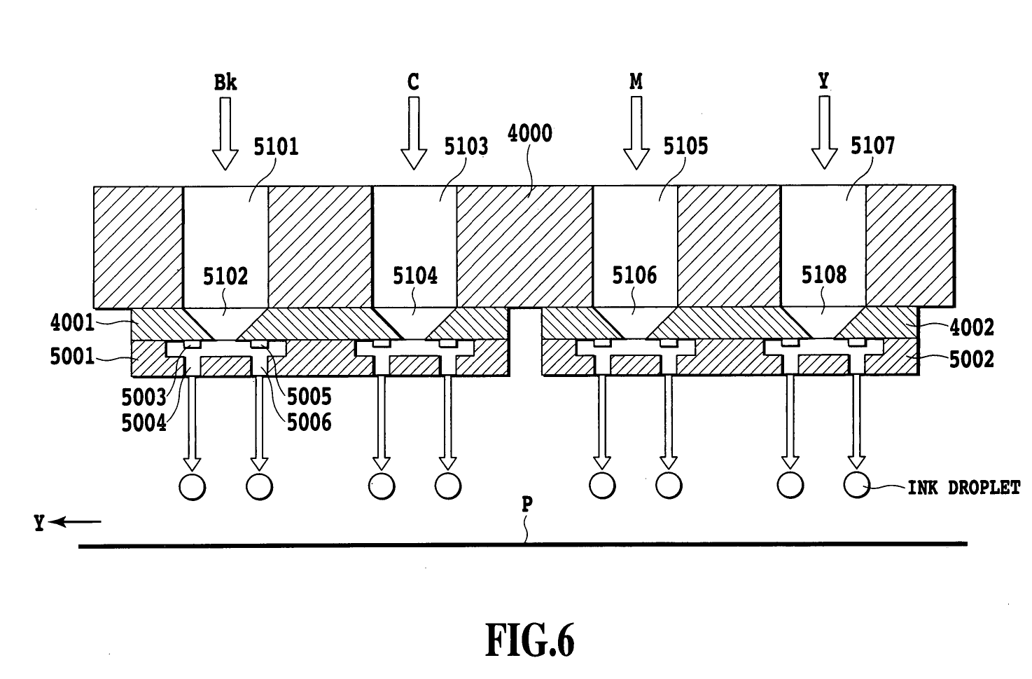

FIG. 6 is a schematic side cross-sectional view showing a more detailed construction of the print head 21.

In FIG. 6, denoted 5102, 5104, 5106 and 5108 are common ink chambers that receive Bk, C, M and Y inks respectively and which are formed by anisotropically etching a back surface of heater boards 4001, 4002 formed by a semiconductor fabrication process. These common ink chambers 5102, 5104, 5106 and 5108 communicate with ink paths associated with the four different inks and are separated from one another so that these inks will not mix. Two nozzle columns are formed for each ink color.

The nozzles in the left and right nozzle columns for the Bk ink are arranged at equal intervals (same pitches) in the nozzle column direction and form a left nozzle group 5004 and a right nozzle group 5006, which are staggered a half pitch from each other. The nozzles of the left nozzle group 5004 are also called even-numbered nozzles and the nozzles of the right nozzle group 5006 odd-numbered nozzles. At positions corresponding to the nozzles 5004, 5006 are provided ejection heaters 5003 and 5005 as an ink ejection energy generation means. The ejection heaters 5003 and 5005 generate thermal energy according to the drive signal to form a bubble in ink, which, as it expands, expels an ink droplet from the nozzles 5004 and 5006. Piezoelectric elements may be used as the ink ejection energy generation means. The nozzle columns for C, M and Y inks are also formed in the similar way, so their explanations are omitted here.

A base plate 4000 is formed with communication portions 5101, 5103, 5105 and 5107 communicating with the common ink chambers 5102, 5104, 5106 and 5108. Denoted 5001 and 5002 are orifice plates that are formed with the ink paths and nozzles and which are normally formed of a heat resistant resin material. P denotes a print medium.

(Printer Driver Screen)

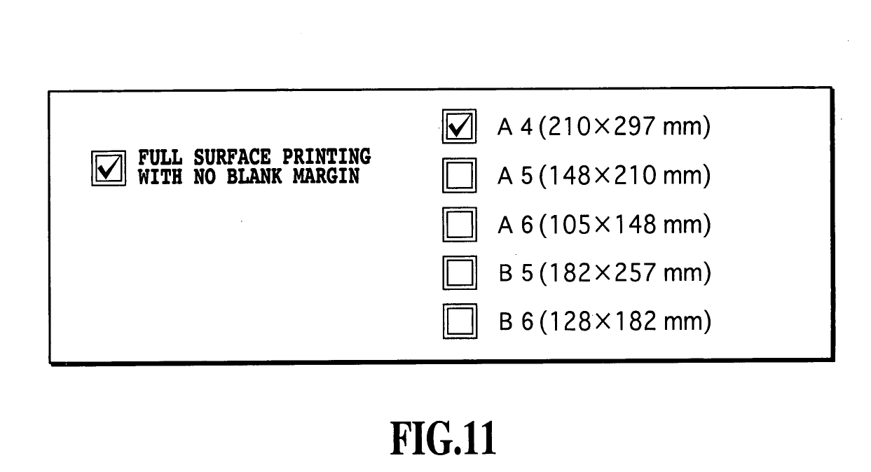

In this embodiment the size of a print medium can be selected by the user inputting information on a user interface screen (driver screen) on a display of the host computer 302 (see FIG. 3). For example, on a driver screen of FIG. 11 on the display, the user selects a desired size of the print medium. The host computer 302 then generates print data suited for the selected size. In this example, the user can select from among five sizes—A4 size (210.0×297.0 mm), A5 size (148.0×210.0 mm), A6 size (105.0×148.0 mm), B5 size (182.0×257.0 mm), and B6 size (128.0×182.0 mm). The user can also set either the margin-less printing or the normal printing (also referred to as a “non margin-less printing” or “margined printing”) by using a check box in FIG. 11.

(Printing Operation)

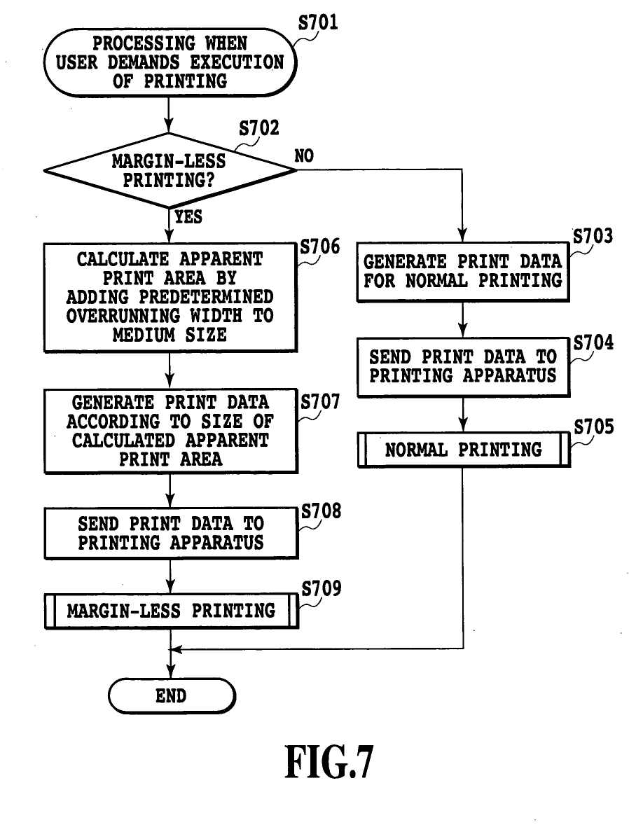

FIG. 7 is a flow chart showing a sequence of steps performed when the user issues an instruction for executing a printing operation.

First, when the user operates the host computer 302 to instruct an execution of printing operation (step S701), the host computer 302 decides which of the margin-less printing and the normal printing is to be performed, according to the setting made by the user on the driver screen of FIG. 11 (step S702). When the normal printing is selected, the host computer 302 generates print data for normal printing (step S703). The print data for normal printing is print data to form an image on a print medium of the size selected on the driver screen of FIG. 11 so that margins are left at the edge portions of the print medium. The host computer 302 sends the print data to the printing apparatus 301 (step S704). The printing apparatus 301, based on the received print data, executes the normal printing (step S705) to form an image on the print medium with margins left on the edge portions.

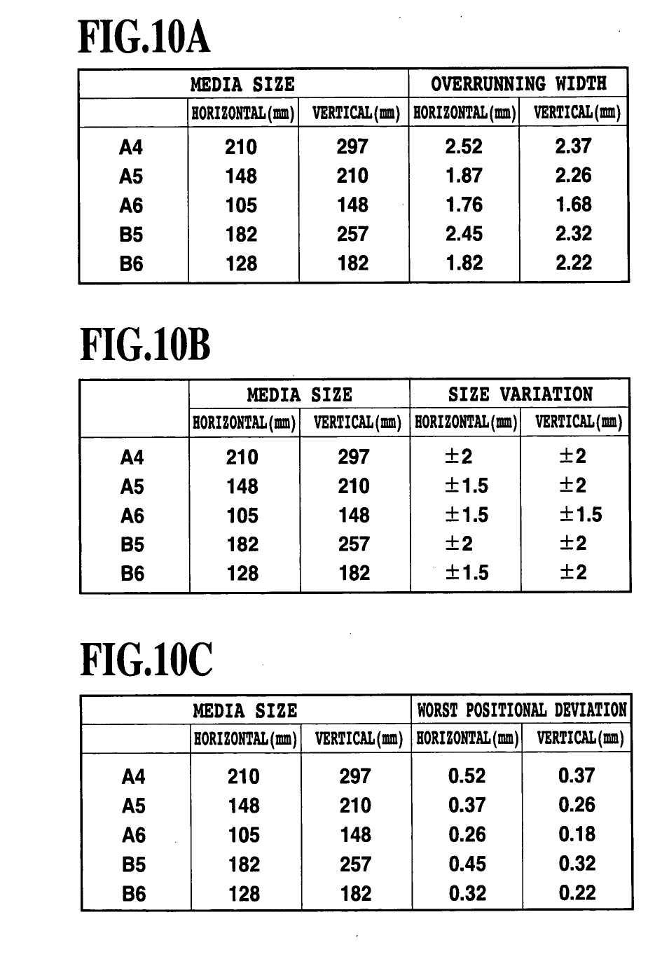

When a margin-less printing is selected, the host computer 302 adds to the size of the print medium selected on the driver screen a preset overrunning width of FIG. 10A to determine a print area which is a predetermined width larger than the print area of the print medium (also referred to as an “apparent print area”) (step S706). For example, when a margin-less printing is performed on a A4-size print medium, a corresponding overrunning width (horizontal width: 2.52 mm; vertical width: 2.37 mm) is added to the A4 size (horizontal width: 210 mm; vertical width: 297 mm) to calculate an apparent print area, which measures 212.52 mm in horizontal length and 299.37 mm in vertical length. The apparent print area comprises a first area on the print medium and a second area overrunning from the print medium, to both of which a colorant is applied.

The overrunning width shown in FIG. 10A determines, for various print medium sizes, the size of an area overrunning from the edge of the print medium to which ink is applied during the margin-less printing. The overrunning width in FIG. 10A is a sum of a print medium size variation shown in FIG. 10B and a worst possible positional deviation shown in FIG. 10C that may occur in the printing apparatus 301.

First, let us explain about the print medium size variation shown in FIG. 10B. In the JIS standard, a dimensional error of ±1.5 mm to ±2.0 mm is tolerated. That is, there is a size variation of ±1.5 mm to ±2.0 mm in each size of print medium. For example, an A4-size print medium (210 mm in horizontal length and 297 mm in vertical length) has a size variation of ±2.0 mm in horizontal length and ±2.0 mm in vertical length.

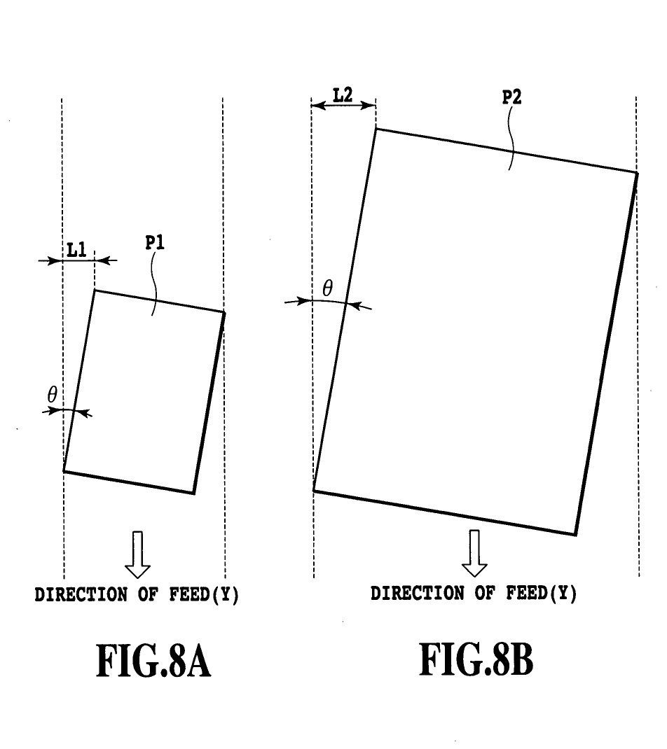

Next, a worst positional deviation shown in FIG. 10C that may occur in the printing apparatus 301 will be explained. In the printing apparatus 301 of this example, an inclination angle of a print medium during feeding does not depend on the size of the print medium P (P1, P2), as can be seen from FIG. 8A and FIG. 8B. The inclination angle is an angle θ of the print medium P (P1, P2) with respect to the direction in which it is transported. If the inclination angles are equal for different print medium sizes as in this example and when a relatively large print medium P2 is printed as shown in FIG. 8B, the amount of deviation L2 is relatively large because the print medium needs to be transported a relatively long distance. Conversely, when a relatively small print medium P1 is printed as shown in FIG. 8A, the amount of deviation L1 is relatively small.

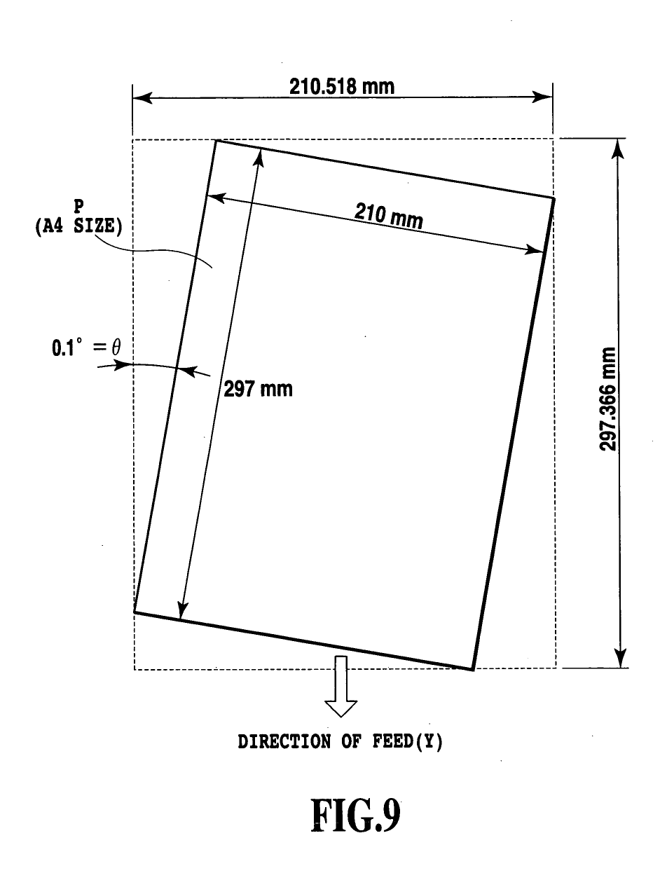

In the printing apparatus 301 of this embodiment, the worst inclination angle of a print medium during transport that considers various transport operation errors including precision errors of the print medium transport mechanism is approximately ±0.1 (degree). For example, if the print medium P of A4 size is transported at an inclination angle of 0.1 degree, as shown in FIG. 9, a horizontal deviation of 0.52 mm (≅210.518 mm−210 mm) and a vertical deviation of 0.37 mm (≅297.336 mm−297 mm) result. For other print medium sizes, the similar condition also applies and their horizontal and vertical deviations are shown in FIG. 10C.

Adding the maximum print medium size variation shown in FIG. 10B to the worst positional deviation shown in FIG. 10C determines an overrunning width in FIG. 10A, i.e., the largest possible overrunning width that may occur with the actual print medium. In the case of A4-size print medium, for example, the horizontal overrunning width is 2.52 mm (2.00 mm+0.52 mm) and the vertical overrunning width is 2.37 mm (2.00 mm+0.37 mm). Thus, an area, which is larger than the print area of the print medium by the overrunning width (FIG. 10A), is set as an apparent print area and then ink is applied to the apparent print area to perform a margin-less printing without forming a margin at any of the edge portions of the print medium. To more reliably prevent the formation of a margin at edge portions of the print medium, the overrunning width may be set with a greater value shown in FIG. 10A.

In step S707 of FIG. 7, the host computer 302 generates print data that matches the size of the apparent print area calculated by step S706, and then sends it to the printing apparatus 301 (step S708). The print data is data which causes ink to be ejected to the apparent print area as if to form an image on the apparent print area. The printing apparatus 301 performs a margin-less printing according to the received print data (step S709).

In this embodiment, an optimum overrunning width is set for the size of the print medium so that the overrunning width is prevented from being set unnecessarily large. This in turn minimizes the amount of ink ejected to areas overrunning from the print medium during the margin-less printing and also minimizes the amount of ink mist produced, reducing a contamination inside the printing apparatus.

When the worst inclination angle varies from one kind of print medium to another because of different characteristics of print media such as rigidity, skin frictional coefficient and thickness, it is preferred that a table of overrunning widths for various print media be provided in advance to set an appropriate overrunning width that matches the inclination angle for each print medium. In this case, an appropriate overrunning width according to the size and the kind of the print medium can be set.

### Second Embodiment

In this embodiment, the overall configuration, the construction of a printing apparatus, and the construction of a print head are similar to those of the first embodiment.

(Printer Driver Screen)

In this embodiment, the size of a print medium can be selected by the user inputting information on a user interface screen (driver screen) on the display of the host computer 302 (see FIG. 3), as in the first embodiment. For example, on the driver screen of FIG. 11 on the display, the user selects a desired size of the print medium. The host computer 302 generates print data suited for the selected size. In this example, the user can select from among five sizes—A4 size (210.0×297.0 mm), A5 size (148.0×210.0 mm), A6 size (105.0×148.0 mm), B5 size (182.0×257.0 mm), and B6 size (128.0×182.0 mm). The user can also set either the margin-less printing or the normal printing (also referred to as a “non margin-less printing” or “margined printing”) by using a check box in FIG. 11.

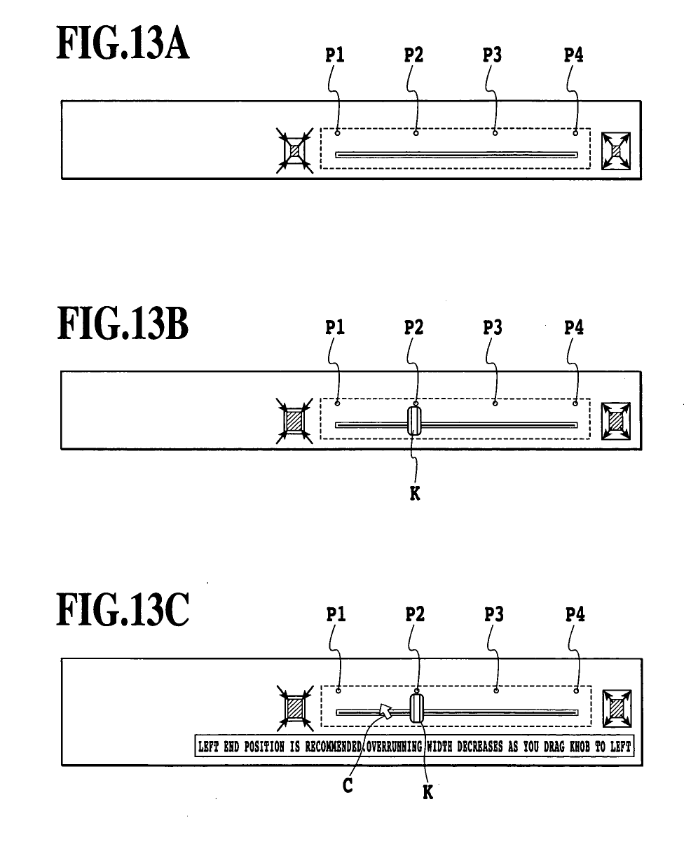

Further in this example, on a driver screen shown in FIG. 13A, FIG. 13B and FIG. 13C, the user can adjust the overrunning width. The overrunning width is specified by dragging a knob K on the screen to left and right. Details of how the overrunning width can be specified will be described later.

When the margin-less printing is not specified on the driver screen of FIG. 11, a user interface screen of FIG. 13A appears. In the screen of FIG. 13A, the knob K is not shown and the overrunning width cannot be specified. When, on the other hand, the margin-less printing is specified on the driver screen of FIG. 11, the knob K appears as shown in FIG. 13B allowing a desired overrunning width to be specified. Placing a cursor C in a field associated with the overrunning width on the screen of FIG. 13B and clicking on it causes the overrunning width specifying item to change into a setting item. That is, instead of the screen of FIG. 13B, a user interface screen of FIG. 13C appears which guides the user in the overrunning width setting procedure by displaying a recommendation by the printer. The printer's recommendation on the overrunning width shown on the screen of FIG. 13C reads “The recommended value is on the left end; the overrunning width becomes smaller as you drag the knob to left.” On the screen of FIG. 13C, the knob K is dragged to one of the four positions P1, P2, P3, P4 to selectively specify a level of the overrunning width (level 1 to level 4) corresponding to the position of the knob K.

(Printing Operation)

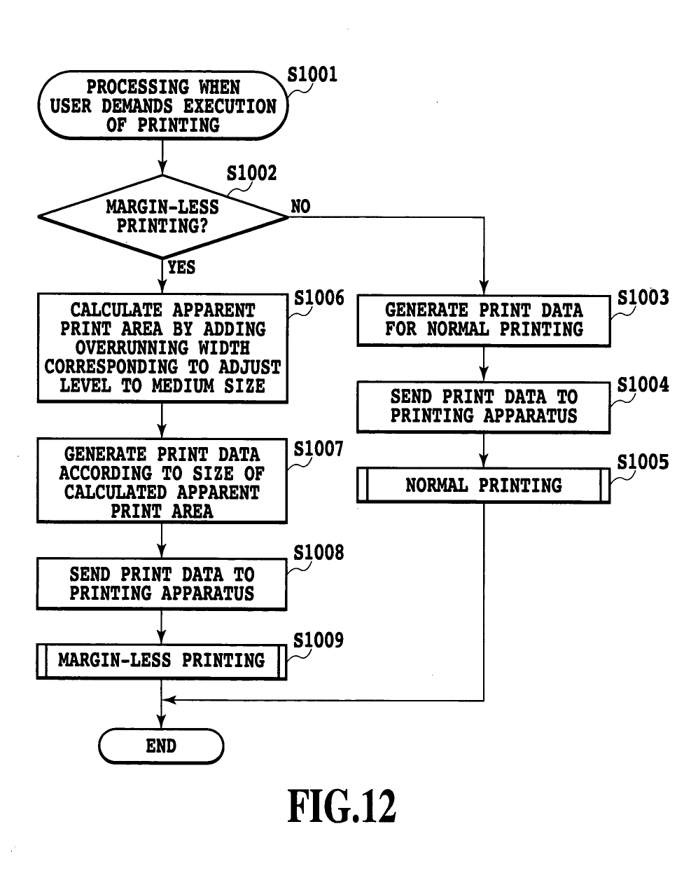

FIG. 12 is a flow chart showing a sequence of operations performed when the user instructs an execution of printing operation.

First, when the user operates the host computer 302 to demand an execution of printing operation (step S1001), the host computer 302 decides which of the margin-less printing and the normal printing is to be performed, according to the setting made by the user on the driver screen of FIG. 11 (step S1002). When the normal printing is selected, the host computer 302 generates print data for normal printing (step S1003). The print data for normal printing is print data to form an image on a print medium of the size selected on the driver screen of FIG. 11 so that margins are left at the edge portions of the print medium. The host computer 302 sends the print data to the printing apparatus 301 (step S1004). The printing apparatus 301, based on the received print data, executes the normal printing (step S1005) to form an image on the print medium with margins left on the edge portions.

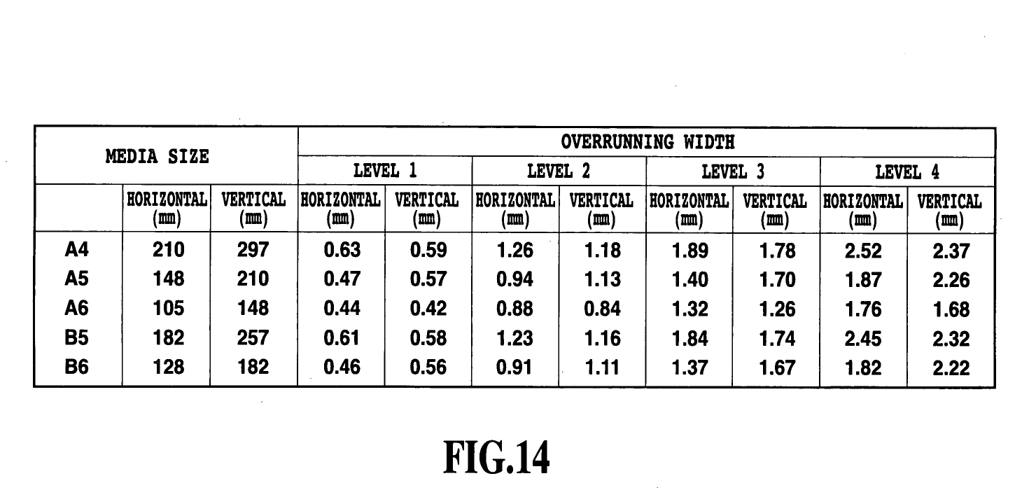

When a margin-less printing is selected, the host computer 302 adds to the size of the print medium selected on the driver screen of FIG. 11 an overrunning width corresponding to the adjust level selected on the driver screen of FIG. 13 to determine a print area which is a predetermined width larger than the print area of the print medium (also referred to as an “apparent print area”) (step S1006). The overrunning widths for the adjust levels are set in advance as shown in FIG. 14. When, for example, a margin-less printing is performed on an A4-size print medium with an overrunning width adjust level 3 selected, the size of the apparent print area is determined to be 211.89 m in horizontal length and 298.78 mm in vertical length by adding the overrunning width of level 3 in FIG. 14 (1.89 mm in horizontal length and 1.78 mm in vertical length) to the A4 size (210 mm in horizontal length and 297 mm in vertical length).

Here, the relation between the adjust level and the overrunning width in FIG. 14 is explained.

The overrunning width corresponding to the adjust level 4 is set with a value of FIG. 10A that considers the print medium size variation shown in FIG. 10B and the worst positional deviation shown in FIG. 10C that may occur with the printing apparatus.

Therefore when the adjust level 4 is set, the margin-less printing can be performed without leaving margins at the edge portions of the print medium even if the print medium size variation and the positional deviation are the worst, as in the first embodiment. However, it is very rare that both the print medium size variation and the positional deviation become worst. When a large overrunning width is set, there is an increased possibility of wasteful use of ink and of contamination by ink mist.

In this example therefore, a mechanism is provided that allows the user to make a desired adjustment of the overrunning width. That is, when the user wishes a reliable margin-less printing with no possibility of margins being left at the edge portions of the print medium, the user sets an adjust level 4. When it is desired that the amount of ink used be reduced although there is a possibility of margins being formed at the edge portions of the print medium, the user may set an adjust level 3 or lower.

In this example, the overrunning widths corresponding to adjust level 1, 2 and 3 are set as follows.
Level 1: 25% of level 4
Level 2: 50% of level 4
Level 3: 75% of level 4

In step S1007 of FIG. 12, the host computer 302 generates print data according to the size of the apparent print area calculated by step S1006 and sends it to the printing apparatus 301 (step S1008). The print data is data which causes ink to be ejected to the apparent print area as if to form an image on the apparent print area. The printing apparatus 301 performs a margin-less printing according to the received print data (step S1009).

In this embodiment, since the user is allowed to make an adjustment to set an optimum overrunning width for the size of a print medium, the overrunning width is prevented from being set excessively large. It is therefore possible to keep to the minimum required the amount of ink ejected to an area overrunning from the edges of the print medium and thereby minimize the consumption of ink and at the same time reduce the amount of ink mist produced and therefore a contamination of the interior of the printing apparatus.

The overrunning width may also be set according to the kind of print medium. A variety of kinds of print media may be used, including glossy paper and matte paper, and size variations differ from one kind to another. The angle of inclination as the print medium is transported in the printing apparatus also differs according to the material and thickness of the print medium. The kind of print medium and the overrunning width can be related to each other as in the case with the relation between the print medium size and the overrunning width shown in FIG. 14. The user can select the kind of print medium using a driver screen similar to FIG. 11 and adjust the overrunning width, which is chosen based on the kind of print medium, by using a driver screen similar to FIG. 13. Since an optimal overrunning width is set according to the kind of print medium through an adjustment made by the user, the overrunning width is prevented from becoming excessively large. This keeps to the minimum required the amount of ink ejected to an area overrunning from the edges of the print medium during the margin-less printing and thereby minimizes the consumption of ink. This arrangement also reduces the amount of ink mist produced and therefore contamination of the interior of the printing apparatus.

It is also possible to set an optimum overrunning width according to both the size and kind of the print medium. In that case, a combination of the print medium size and kind may be associated with the overrunning width, thus allowing the user to select an appropriate overrunning width according to the print medium size and kind.

### Third Embodiment

In this embodiment, the overall configuration, the construction of a printing apparatus, and the construction of a print head are similar to those of the first embodiment.

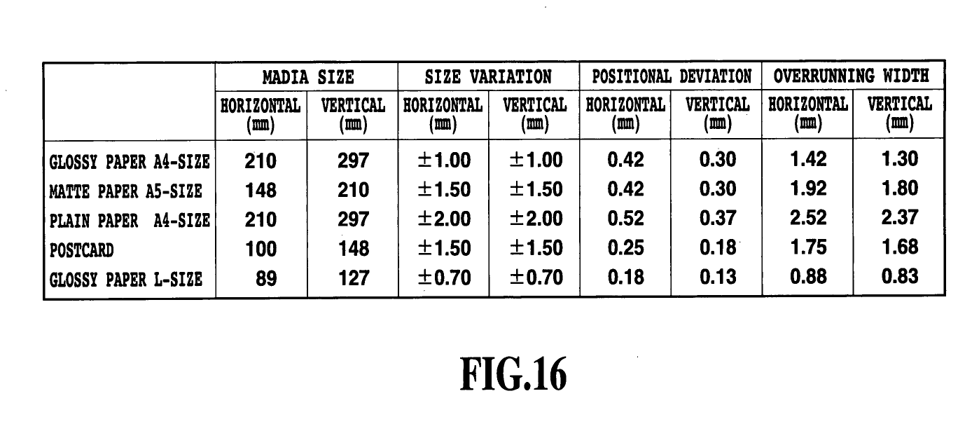

A variety of kinds of print media is available for ink jet printing apparatus, such as glossy paper and matte paper, and the method of manufacture and characteristics vary according to the kind of print medium. Thus, a range of size variation caused by cutting precision errors differs from one kind of print medium to another. Positional deviations of a print medium as it is transported in the printing apparatus also vary according to the material and thickness of the print medium. In this embodiment, an optimal overrunning width is set according to the kind and size of the print medium by using a preset table of FIG. 16.

In FIG. 16, plain paper and postcards are made of commonly available materials and the positional deviations of the A4-size plain paper and postcard are calculated from the inclination angle of 0.1 degree and the print medium size, as in the case of the preceding embodiments.

The cutting precision of glossy paper can be made higher than that of plain paper because of its fabrication process and its size variation can be kept to about one-half that of plain paper. Thus, A4-size glossy paper has a size variation of +1.00 mm in horizontal length and ±1.00 mm in vertical length and L-size glossy paper has a size variation of ±0.70 mm in horizontal length and ±0.70 mm in vertical length. The cutting precision of matte paper is intermediate between those of plain paper and glossy paper, so A4-size matte paper has a size variation of ±1.50 mm in horizontal length and ±1.50 mm in vertical length. The inclination angles of the glossy paper and matte paper are 20% smaller than those of plain paper and postcards. Thus, the A4-size glossy paper has a positional deviation of ±0.42 mm in horizontal direction and +0.30 mm in vertical direction and L-size glossy paper has a positional deviation of ±0.18 mm in horizontal direction and ±0.13 mm in vertical direction. A4-size matte paper has a positional deviation of ±0.42 mm in horizontal direction and ±0.30 mm in vertical direction. In FIG. 16 the overrunning widths for different print media are the sum of the size variation and the positional deviation.

(Printing Operation)

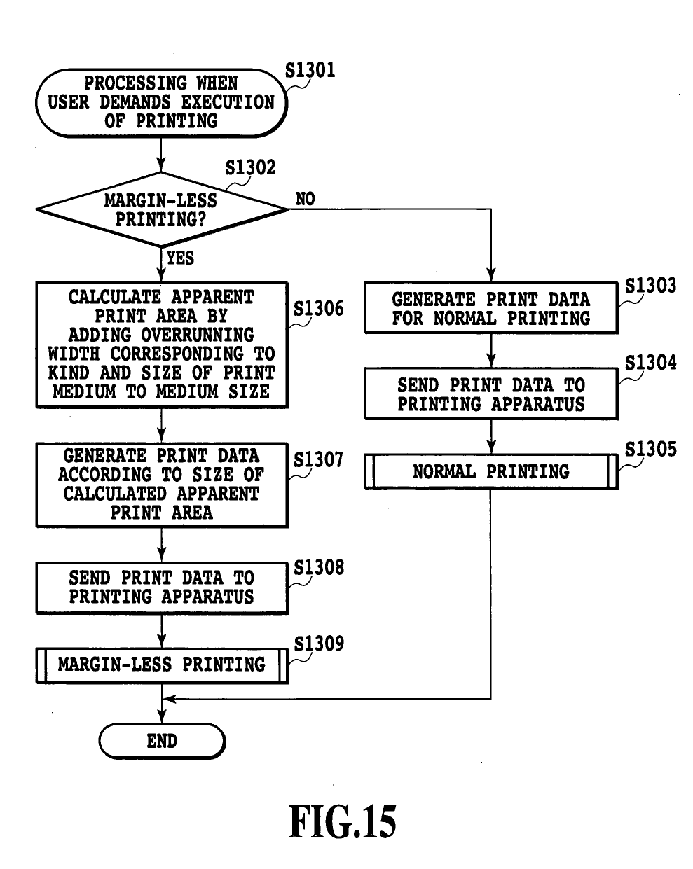

FIG. 15 is a flow chart showing a sequence of operations performed when the user instructs an execution of printing operation.

First, when the user operates the host computer 302 to demand an execution of printing operation (step S1301), the host computer 302 decides which of the margin-less printing and the normal printing is to be performed, according to the setting made by the user on the driver screen of FIG. 11 (step S1302). When the normal printing is selected, the host computer 302 generates print data for normal printing (step S1303). The print data for normal printing is print data to form an image on a print medium of the size selected on the driver screen of FIG. 11 so that margins are left at the edge portions of the print medium. The host computer 302 sends the print data to the printing apparatus 301 (step S1304). Based on the received print data, the printing apparatus 301 executes the normal printing (step S1305) to form an image on the print medium with margins left on the edge portions.

When a margin-less printing is selected, the host computer 302, based on the size and kind of the print medium selected on the driver screen of FIG. 11, reads overrunning widths corresponding to the print medium from the table of FIG. 16. Then, the overrunning width corresponding to the kind and size of the print medium is added to the print medium size to determine a print area which is a predetermined width larger than the print area of the print medium (also referred to as an “apparent print area”) (step S1306). When, for example, a margin-less printing is performed on A4-size glossy paper, the corresponding overrunning width in FIG. 16 (1.42 mm in horizontal direction and 1.30 mm in vertical direction) is added to the A4 size (210 mm in horizontal length and 297 mm in vertical length) to determine an apparent print area 211.42 mm wide and 298.30 mm long.

Then in step S1307, the host computer 302 generates print data corresponding to the size of the apparent print area calculated by step S1306 and sends it to the printing apparatus 301 (step S1308). The print data is data which causes ink to be ejected to the apparent print area as if to form an image on the apparent print area. The printing apparatus 301 performs a margin-less printing according to the received print data (step S1309).

This embodiment takes into consideration even the characteristics of individual kinds of print media and thus can set a more optimal overrunning width.

### Other Embodiments

The adjustment of the overrunning width may also be made continuously, as well as stepwise as in the above embodiment. A state of adjustment of the overrunning width may also be displayed on a screen for the user to confirm. In that case, an image of an ink application area whose size and position change as the overrunning width is adjusted may be shown overlapped over an outline image of a print medium.

In addition to the ink jet printing system using an ink jet print head, various other printing systems may be employed for the printing apparatus. The ink ejection system of the ink jet print head is not limited to the one using electrothermal transducers and may, for example, use piezoelectric elements for ink ejection.

The present invention has been described in detail with respect to preferred embodiments, and it will now be apparent from the foregoing to those skilled in the art that changes and modifications may be made without departing from the invention in its broader aspect, and it is the intention, therefore, in the apparent claims to cover all such changes.

This application claims priority from Japanese Patent Application No. 2004-170464 filed Jun. 8, 2004, which is hereby incorporated by reference herein.

1. A printing condition setting method for setting a condition which is used to perform a margin-less printing, the margin-less printing performing printing on a print medium without providing a margin at an edge portion of the print medium by applying a colorant to the print medium based on print data larger in size than the print medium to be printed, the printing condition setting method comprising:
a step of specifying an overrunning width of the print data that overruns outwardly from the print medium to be printed;
wherein the specifying step specifies the overrunning width according to a kind and a size of the print medium to be printed.

2. A printing condition setting method according to claim 1, wherein the margin-less printing is performed by printing an image on the print medium without providing a margin at at least one edge portion of the print medium.

3. A printing condition setting method according to claim 1, further comprising a step of setting a margin-less print mode to execute the margin-less printing;
wherein the setting step is executed prior to the specifying step.

4. A printing condition setting method according to claim 1, further comprising a step of generating the print data according to the overrunning width specified by the specifying step.

5. A printing condition setting method according to claim 4, wherein the generation step generates the print data of a size which is a sum of the overrunning width specified by the specifying step and a size of the print medium to be printed.

6. A printing condition setting method according to claim 1, wherein the larger the size of the print medium, the greater overrunning amount the specifying step specifies.

7. A printing condition setting method according to claim 1, wherein the kind of the print medium includes at least one of thickness and rigidity of the print medium, a kind of ink accepting layer and a kind of base material.

8. A printing condition setting method for setting a condition which is used to perform a margin-less printing, the margin-less printing performing printing on a print medium without providing a margin at an edge portion of the print medium by applying a colorant to the print medium based on print data larger in size than the print medium to be printed, the printing condition setting method comprising:
a step of specifying an overrunning width of the print data that overruns outwardly from the print medium to be printed;
wherein the specifying step specifies the overrunning width according to at least one of a kind and a size of the print medium to be printed and to one level selected from a plurality of levels representing magnitudes of the overrunning width.

9. A printing condition setting method according to claim 8, wherein the plurality of levels are set stepwise in advance according to at least one of the kind and size of the print medium.

10. A program for setting a condition which is used to perform a margin-less printing, the margin-less printing performing printing on a print medium without providing a margin at an edge portion of the print medium by applying a colorant to the print medium based on print data larger in size than the print medium to be printed,
the program causing a computer to execute a step of specifying an overrunning width of the print data that overruns outwardly from the print medium to be printed;
wherein the specifying step specifies the overrunning width according to at least one of a kind and a size of the print medium to be printed and to one level selected from a plurality of levels representing magnitudes of the overrunning width.

11. A program for setting a condition which is used to perform a margin-less printing, the margin-less printing performing printing on a print medium without leaving a margin at an edge portion of the print medium by applying a colorant to the print medium based on print data larger in size than the print medium to be printed,
the program causing a computer to execute a step of specifying an overrunning width of the print data, which overruns outwardly from the print medium to be printed, according to a kind and a size of the print medium.

12. A printing method for executing a margin-less printing, the margin-less printing performing printing on a print medium without leaving a margin at an edge portion of the print medium by applying a colorant to the print medium based on print data larger in size than the print medium to be printed, the printing method comprising the steps of:
a step of specifying an overrunning width of the print data, which overruns outwardly from the print medium, according to at least one of a kind and a size of the print medium to be printed and to one level selected from a plurality of levels representing magnitudes of the overrunning width;
a step of generating the print data larger in size than the print medium to be printed, according to the specified overrunning width; and
a step of applying the colorant to the print medium according to the generated print data.

13. A printing method for executing a margin-less printing, the margin-less printing performing printing on a print medium without providing a margin at an edge portion of the print medium by applying a colorant to the print medium based on print data larger in size than the print medium to be printed, the printing method comprising the steps of:
a step of specifying an overrunning width of the print data, which overruns outwardly from the print medium to be printed, according to a kind and a size of the print medium;
a step of generating the print data larger in size than the print medium to be printed, according to the specified overrunning width; and
a step of applying the colorant to the print medium according to the generated print data.

14. A printing apparatus for executing a margin-less printing, the margin-less printing performing printing on a print medium without providing a margin at an edge portion of the print medium by applying a colorant to the print medium based on print data larger in size than the print medium to be printed, the printing apparatus comprising:
means for specifying an overrunning width of the print data, which overruns outwardly from the print medium, according to at least one of a kind and a size of the print medium to be printed and to one level selected from a plurality of levels representing magnitudes of the overrunning width;
means for generating the print data larger in size than the print medium to be printed, according to the specified overrunning width; and
means for applying the colorant to the print medium according to the generated print data.

15. A printing apparatus for executing a margin-less printing, the margin-less printing performing printing on a print medium without providing a margin at an edge portion of the print medium by applying a colorant to the print medium based on print data larger in size than the print medium to be printed, the printing apparatus comprising:
means for specifying an overrunning width of the print data, which overruns outwardly from the print medium to be printed, according to a kind and a size of the print medium to be printed;
means for generating the print data larger in size than the print medium to be printed, according to the specified overrunning width; and
means for applying the colorant to the print medium according to the generated print data.

16. A printing condition deciding apparatus capable of determining a condition under which to perform a margin-less printing, the margin-less printing performing printing on a print medium without leaving a margin at an edge portion of the print medium by applying a colorant to the print medium based on print data larger in size than the print medium to be printed, the printing condition deciding apparatus comprising:
means for specifying an overrunning width of the print data that overruns outwardly from the print medium to be printed;
means for generating the print data according to the overrunning width specified by the specifying means; and
means for transferring the generated print data to a printing apparatus that performs the margin-less printing;
wherein the specifying means specifies the overrunning width according to at least one of a kind and a size of the print medium to be printed and to one level selected from a plurality of levels representing magnitudes of the overrunning width.

17. A printing condition deciding apparatus capable of determining a condition under which to perform a margin-less printing, the margin-less printing performing printing on a print medium without leaving a margin at an edge portion of the print medium by applying a colorant to the print medium based on print data larger in size than the print medium to be printed, the printing condition deciding apparatus comprising:
means for specifying an overrunning width of the print data, which overruns outwardly from the print medium to be printed, according to a kind and a size of the print medium;
means for generating the print data according to the overrunning width specified by the specifying means; and
means for transferring the generated print data to a printing apparatus that performs the margin-less printing.
